(19) United States
(12) Patent Application Publication
(10) Pub. No.: US 2020/0183407 A1
(43) Pub. Date: Jun. 11, 2020

(54) METHOD, APPARATUS AND MEDIUM FOR ENABLING SELF-DRIVING VENDING MACHINE TO COPE WITH WEATHER ENVIRONMENT

(71) Applicant: BEIJING BAIDU NETCOM SCIENCE AND TECHNOLOGY CO., LTD., Beijing (CN)

(72) Inventors: Ning YU, Beijing (CN); Zhijie WANG, Beijing (CN)

(73) Assignee: BEIJING BAIDU NETCOM SCIENCE AND TECHNOLOGY CO., LTD., Beijing (CN)

(21) Appl. No.: 16/653,175

(22) Filed: Oct. 15, 2019

(30) Foreign Application Priority Data
Dec. 11, 2018 (CN) 2018115098208

(51) Int. Cl. G05D 1/02; G07F 11/00; G01C 21/34; B60J 11/04; B60P 3/025

(52) U.S. Cl. CPC G05D 1/0225; G07F 11/002; G05D 2201/02; B60J 11/04; B60P 3/0257; G01C 21/3415

(57) ABSTRACT

A method, an apparatus and a medium for enabling a self-driving vending machine to cope with a weather environment are proposed. The method comprises: obtaining information about a weather environment of a place where the self-driving vending machine is located; in response to determining that a protective measure needs to be taken according to the information about the weather environment, performing protection for the self-driving vending machine according to a preset protective measure. The technical solution may be applied to avoid the impacts caused by weather factors to the recognition capability of the sensors of the self-driving vending machine and the user's purchasing behaviors, and thereby ensuring normal use of the self-driving vending machine.

### CROSS REFERENCE TO RELATED APPLICATION

This application claims priority to Chinese Patent Application No. 201811509820.8, filed on Dec. 11, 2018, which is incorporated herein by reference in its entirety.

### TECHNICAL FIELD

The present disclosure relates to computer application technology, and particularly to a method, an apparatus and a medium for enabling a self-driving vending machine to cope with a weather environment.

### BACKGROUND

A self-driving vending machine implements a function of a vending machine on a self-driving vehicle, or integrating a conventional vending machine on a self-driving vehicle.

The self-driving vending machine usually works in an outdoor open environment. However, the outdoor open environment might be faced with various possible weather conditions such as rainy day.

The rainy environment will affect a recognition capability of sensors in the self-driving vending machine as well as customers' purchasing behaviors, thereby affecting normal use of the self-driving vending machine.

### SUMMARY

In view of the above, the present disclosure proposes a method, an apparatus and a medium for enabling a self-driving vending machine to cope with a weather environment.

Specific technical solutions are as follows:

According to an embodiment, a method for enabling a self-driving vending machine to cope with a weather environment is proposed, the method may include:

obtaining information about a weather environment of a place where the self-driving vending machine is located;

in response to determining that a protective measure needs to be taken according to the information about the weather environment, performing protection for the self-driving vending machine according to a preset protective measure.

According to an embodiment of the present disclosure, obtaining information about a weather environment of a place where the self-driving vending machine is located may include:

obtaining the information about the weather environment collected by a camera and/or sensor mounted on the self-driving vending machine.

According to an embodiment of the present disclosure, determining that a protective measure needs to be taken according to the information about the weather environment may include:

determining that the protective measure needs to be taken if determining, according to the information about the weather environment, that the weather is at least one of the following conditions: it is raining, it is raining and the rainfall thereof is larger than a preset first threshold, it is snowing, it is snowing and the snowfall thereof is larger than a preset second threshold, or air temperature is higher than a preset third threshold.

According to an embodiment of the present disclosure, performing protection for the self-driving vending machine according to a preset protective measure may include:

controlling the opening of a protective device that is disposed on the roof of the self-driving vending machine and capable of covering the self-driving vending machine.

According to an embodiment of the present disclosure, performing protection for the self-driving vending machine according to a preset protective measure may include:

determining a temporary shelter location;

controlling the self-driving vending machine to drive automatically to the temporary shelter location for parking.

According to an embodiment of the present disclosure, determining a temporary shelter location may include:

determining the temporary shelter location according to a location of the self-driving vending machine; or

reporting the location of the self-driving vending machine to a control center, and obtaining the temporary shelter location which is returned by the control center and determined according to the location of the self-driving vending machine.

According to an embodiment of the present disclosure, the temporary shelter location may include at least one of:

a temporary shelter location nearest to the self-driving vending machine; or

a temporary shelter location with the shortest driving time from the self-driving vending machine.

According to an embodiment, an apparatus for enabling a self-driving vending machine to cope with a weather environment is proposed, the apparatus may include:

an obtaining unit for obtaining information about a weather environment of the place where the self-driving vending machine is located;

an executing unit for, in response to determining that a protective measure needs to be taken according to the information about the weather environment, performing protection for the self-driving vending machine according to a preset protective measure.

According to an embodiment of the present disclosure, the obtaining unit obtains the information about the weather environment collected by a camera and/or a sensor mounted on the self-driving vending machine.

According to an embodiment of the present disclosure, the executing unit determines that the protective measure needs to be taken if determining, according to the information about the weather environment, that the weather is at least one of the following conditions: it is raining, it is raining and the rainfall thereof is larger than a preset first threshold, it is snowing, it is snowing and the snowfall thereof is larger than a preset second threshold, or air temperature is higher than a preset third threshold.

According to an embodiment of the present disclosure, in response to determining, according to the information about the weather environment, that the protective measure needs to be taken, the executing unit controls the opening of a protective device that is disposed on the roof of the self-driving vending machine and capable of covering the self-driving vending machine.

According to an embodiment of the present disclosure, in response to determining, according to the information about the weather environment, that the protective measure needs to be taken, the executing unit determines a temporary shelter location, and controls the self-driving vending machine to drive automatically to the temporary shelter location for parking.

According to an embodiment of the present disclosure, the executing unit determines the temporary shelter location according to the location of the self-driving vending machine, or reports the location of the self-driving vending machine to a control center and obtains the temporary shelter location which is returned by the control center and determined according to the location of the self-driving vending machine.

According to an embodiment of the present disclosure, the temporary shelter location may include at least one of:

a temporary shelter location nearest to the self-driving vending machine; or

a temporary shelter location with the shortest driving time from the self-driving vending machine.

According to an embodiment, a computer device is proposed. The computer device may include a memory, a processor and a computer program which is stored on the memory and runs on the processor, the processor, upon executing the program, implementing the above-mentioned method.

According to an embodiment, it is proposed a computer-readable storage medium on which a computer program is stored, the program, when executed by the processor, implementing the aforesaid method.

As can be seen from the above introduction, with the technical solutions of the present disclosure, it is possible to obtain information about a weather environment of a place where the self-driving vending machine is located, then determine whether to take a protective measure according to the information about the weather environment, and if yes, protect the self-driving vending machine according to the preset protective measure, thereby avoiding the impacts caused by weather factors to the recognition capability of the sensors of the self-driving vending machine and the user's purchasing behaviors, and thereby ensuring normal use of the self-driving vending machine.

### BRIEF DESCRIPTION OF THE DRAWINGS

FIG. 1 is a flow chart of a method for enabling a self-driving vending machine to cope with a rainy day according to a first embodiment of the present disclosure.

FIG. 2 is a flow chart of a method for enabling a self-driving vending machine to cope with a rainy day according to a second embodiment of the present disclosure.

FIG. 3 is a flow chart of a method for enabling a self-driving vending machine to cope with a rainy day according to a third embodiment of the present disclosure.

FIG. 4 is a structural schematic diagram of components of an apparatus for enabling a self-driving vending machine to cope with a weather environment according to an embodiment of the present disclosure.

FIG. 5 illustrates a block diagram of an example computer system/server 12 adapted to implement an implementation mode of the present disclosure.

### DETAILED DESCRIPTION

Technical solutions of the present disclosure will be described in more detail in conjunction with figures and embodiments to make technical solutions of the present disclosure clear and more apparent.

Obviously, the described embodiments are partial embodiments of the present disclosure, not all embodiments. Based on embodiments in the present disclosure, all other embodiments obtained by those having ordinary skill in the art without making inventive efforts all fall within the protection scope of the present disclosure.

In addition, it should be appreciated that the term “and/or” used in the text is only an association relationship depicting associated objects and indicates that three relations might exist, for example, A and/or B may represent three cases, namely, A exists individually, both A and B coexist, and B exists individually. In addition, the symbol “/” in the text generally indicates associated objects before and after the symbol are in an “or” relationship.

The present disclosure provides a method for enabling a self-driving vending machine to cope with a weather environment, comprising: obtaining information about a weather environment of the place where a self-driving vending machine is located; in response to determining, according to the information about the weather environment, that it is necessary to take a protective measure, protecting the self-driving vending machine according to a preset protective measure.

The information about the weather environment collected by a camera and/or a sensor installed on the self-driving vending machine may be obtained.

Determining whether to take a protective measure according to the obtained information about the weather environment may for example includes but not limited to the following cases:

determining that the protective measure needs to be taken if it is determined according to the information about the weather environment that it is raining;

or, determining that the protective measure needs to be taken if it is determined according to the information about the weather environment that it is raining and the rainfall thereof is larger than a preset first threshold;

or, determining that a protective measure needs to be taken if it is determined according to the information about the weather environment that it is snowing;

or, determining that a protective measure needs to be taken if it is determined according to the information about the weather environment that it is snowing and the snowfall thereof is larger than a preset second threshold;

or, determining that a protective measure needs to be taken if it is determined according to the information about the weather environment that air temperature is higher than a preset third threshold.

Specific values of the first threshold, the second threshold and the third threshold may be determined according to actual needs.

When it is determined that protective measure needs to be taken, a protective device that is disposed on the roof of the self-driving vending machine and capable of covering the self-driving vending machine may be controlled to be opened, or a temporary shelter location may be determined in advance, and then the self-driving vending machine may be controlled to drive to the temporary shelter location for parking. Which type of protective measure specifically taken, is not limited here.

The technical solution of the present disclosure will be described below in detail by taking a method for coping with a rainy day in which the self-driving vending machine is located as an example. Correspondingly, the protective measure may be a measure of taking shelter from rain, the protective device may be an umbrella, and the temporary shelter location may be a location for taking shelter from rain.

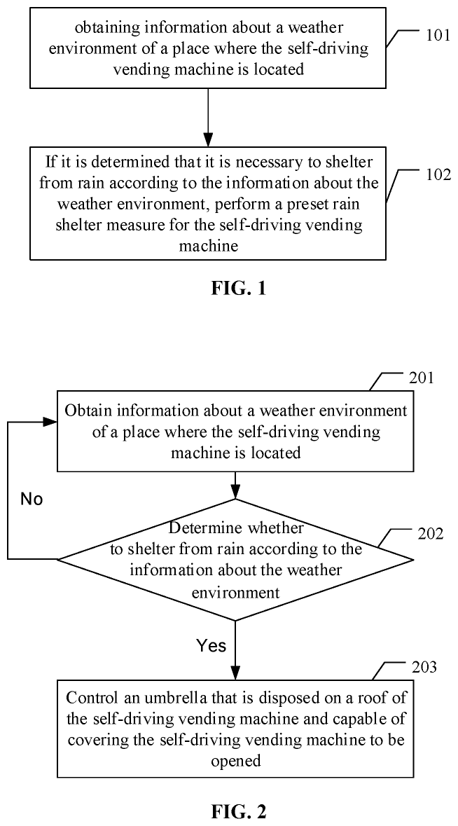

FIG. 1 is a flow chart of a method for enabling a self-driving vending machine to cope with a rainy day according to a first embodiment of the present disclosure. As shown in FIG. 1, the embodiment may include the following specific implementation mode:

At 101, information about a weather environment of the place where the self-driving vending machine is located is obtained.

At 102, in response to determining that it is necessary to shelter from rain according to the information about the weather environment, a preset rain shelter measure is performed for the self-driving vending machine.

It is possible to obtain image information which is about the environment of the place where the self-driving vending machine is located and is collected by a camera mounted on the self-driving vending machine, and/or, obtain humidity information which is about the environment of the place where the self-driving vending machine is located and is collected by a humidity sensor mounted on the self-driving vending machine.

Furthermore, whether to shelter from rain is determined by analyzing the obtained image information and/or humidity information. For example, if it is determined according to the information about the weather environment that it is raining, it may be determined that sheltering from rain needs to be performed, or if it is determined according to the information about the weather environment that it is raining and the rainfall thereof is larger than the preset first threshold, it may be determined that sheltering from rain needs to be performed.

In practical application, it is possible to obtain humidity information which is about the environment of the place where the self-driving vending machine is located and is collected by a humidity sensor mounted on the self-driving vending machine. The humidity sensor may be mounted outside the vehicle body, at a specific location not limited here.

Whether it is raining may be determined based on the humidity information collected by the humidity sensor. If yes, it may be determined that sheltering from rain needs to be performed. That is to say, the rain-sheltering measure may be taken so long as it is determined that it is raining. Alternatively, whether it is raining may be determined based on the humidity information collected by the humidity sensor. If yes, the rainfall thereof may be further determined, and the determined rainfall is compared with the preset first threshold, and it may be determined that sheltering from rain needs to be performed if the rainfall is larger than the first threshold. That is to say, if the rainfall is smaller and almost does not cause an impact to the vehicle, the rain-sheltering measure may not be taken. On the contrary, if the rainfall is larger and might cause an impact to the vehicle, the rain-sheltering measure may be taken.

Optionally, it is possible to obtain image information which is about the environment of the place where the self-driving vending machine is located and is collected by a camera mounted on the self-driving vending machine. Whether it is raining may be determined based on the image information collected by the camera. If yes, it may be determined that sheltering from rain needs to be performed.

The camera may include a binocular camera located in front of the vehicle, monocular cameras located on both sides of the vehicle and a monocular camera located in the rear of the vehicle.

Optionally, it is possible to obtain image information which is about the environment of the place where the self-driving vending machine is located and is collected by a camera mounted on the self-driving vending machine, and obtain humidity information which is about the environment of the place where the self-driving vending machine is located and is collected by a humidity sensor mounted on the self-driving vending machine, thereby determining whether to shelter from rain by analyzing the obtained image information and humidity information.

For example, verification may be further performed based on the image information after it is determined based on the humidity information that it is raining. If it is also determined based on the image information that it is raining, it may be finally determined that it is raining, thereby improving the accuracy of the determination result, and then the rainfall may be further determined based on the humidity information.

If it is determined that sheltering from rain needs to be performed, the preset rain sheltering measure may be performed for the self-driving vending machine.

Based on the above introduction, FIG. 2 is a flow chart of a method for enabling a self-driving vending machine to cope with a rainy day according to a second embodiment of the present disclosure. As shown in FIG. 2, the embodiment may include the following specific implementation mode.

At 201, information about a weather environment of a place where the self-driving vending machine is located is obtained.

At 202, whether to shelter from rain is determined according to the information about the weather environment, and if yes, 203 will be performed, otherwise 201 is performed repeatedly.

For example, it is possible to obtain image information which is about the environment of the place where the self-driving vending machine is located and is collected by a camera mounted on the self-driving vending machine, and/or, obtain humidity information which is about the environment of the place where the self-driving vending machine is located and is collected by a humidity sensor mounted on the self-driving vending machine, thereby determining whether to shelter from rain by analyzing the obtained image information and/or humidity information.

If it is determined according to the image information and/or humidity information that it is raining, it may be determined that sheltering from rain needs to be performed, or if it is determined according to the image information and/or humidity information that it is raining and the rainfall thereof is larger than a preset first threshold, it may be determined that sheltering from rain needs to be performed, and then 203 may be performed, otherwise it is possible to continue to obtain the collected image information and/or humidity information and perform analysis.

At 203, an umbrella that is disposed on the roof of the self-driving vending machine and capable of covering the self-driving vending machine is controlled to be opened.

The umbrella may be disposed on the top of the vehicle. The umbrella is in folded state when not in use. When the umbrella needs to be used, the umbrella may be controlled to be opened, thereby covering the self-driving vending machine. The umbrella does not affect a sensing system of the vehicle.

When the rain stops, the umbrella may be controlled to be closed.

FIG. 3 is a flow chart of a method for enabling a self-driving vending machine to cope with a rainy day according to a third embodiment of the present disclosure. As shown in FIG. 3, the embodiment may include the following specific implementation mode.

At 301, information about a weather environment of a place where the self-driving vending machine is located is obtained.

At 302, whether to shelter from rain is determined according to the information about the weather environment, and if yes, 303 will be performed, otherwise 301 is performed repeatedly.

For example, it is possible to obtain image information which is about the environment of the place where the self-driving vending machine is located and is collected by a camera mounted on the self-driving vending machine, and/or, obtain humidity information which is about the environment of the place where the self-driving vending machine is located and is collected by a humidity sensor mounted on the self-driving vending machine, thereby determining whether to shelter from rain by analyzing the obtained image information and/or humidity information.

If it is determined according to the image information and/or humidity information that it is raining, it may be determined that sheltering from rain needs to be performed, or if it is determined according to the image information and/or humidity information that it is raining and the rainfall thereof is larger than a preset first threshold, it may be determined that sheltering from rain needs to be performed, and then 303 may be performed, otherwise it is possible to continue to obtain the collected image information and/or humidity information and perform analysis.

At 303, determine a rain shelter location and control the self-driving vending machine to drive automatically to the rain shelter location for shelter.

The rain shelter location may be determined according to the location of the self-driving vending machine. Optionally, it is possible to report the location of the self-driving vending machine to a control center, and obtain the rain shelter location which is returned by the control center and determined according to the location of the self-driving vending machine.

The determined rain shelter location may be a rain shelter location nearest to the self-driving vending machine, or a rain shelter location with the shortest driving time from the self-driving vending machine.

The rain shelter location nearest to the self-driving vending machine may be determined, or the rain shelter location with the shortest driving time from the self-driving vending machine may be determined according to location information of pre-stored rain shelter locations or according to location information of rain shelter locations found from search in conjunction with the location of the self-driving vending machine, by performing processing such as path search and path planning. After obtaining the location of the self-driving vending machine, the control center may determine the rain shelter location in a similar manner.

The rain shelter location may be a storehouse where the self-driving vending machine can be parked.

After the rain shelter location is determined, the self-driving vending machine may be controlled to drive automatically to the rain shelter location for shelter. How to control the self-driving vending machine to drive automatically to the rain shelter location is of the prior art.

After the rain stops, the self-driving vending machine may be controlled to drive automatically away from the rain shelter location, and continue normal vending operations.

As appreciated, for ease of description, the aforesaid method embodiments are all described as a combination of a series of actions, but those skilled in the art should appreciated that the present disclosure is not limited to the described order of actions because some steps may be performed in other orders or simultaneously according to the present disclosure. Secondly, those skilled in the art should appreciate the embodiments described in the description all belong to preferred embodiments, and the involved actions and modules are not necessarily requisite for the present disclosure.

In the above embodiments, embodiments are respectively described with respective focuses, and reference may be made to related depictions in other embodiments for portions not detailed in a certain embodiment.

In summary, with the technical solutions of the method embodiments of the present disclosure, it is possible to obtain information about a weather environment of the place where the self-driving vending machine is located, then determine whether to take a protective measure according to the information about the weather environment, and if yes, protect the self-driving vending machine according to the preset protective measure, thereby avoiding the impacts caused by weather factors to the recognition capability of the sensors of the self-driving vending machine and the user's purchasing behaviors, and thereby ensuring normal use of the self-driving vending machine.

The above introduces the method embodiments. The technical solution of the present disclosure will be further described through an apparatus embodiment.

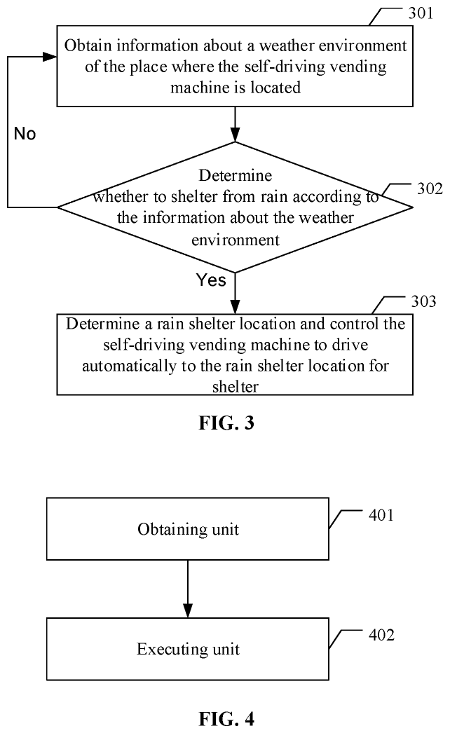

FIG. 4 is a structural schematic diagram of components of an apparatus for enabling a self-driving vending machine to cope with a weather environment according to an embodiment of the present disclosure. As shown in FIG. 4, the apparatus may include an obtaining unit 401 and an executing unit 402.

The obtaining unit 401 is configured to obtain information about a weather environment of a place where the self-driving vending machine is located.

The executing unit 402 is configured to, in response to determining according to the information about the weather environment that a protective measure needs to be taken, perform protection for the self-driving vending machine according to a preset protective measure.

The obtaining unit 401 may obtain the information about the weather environment collected by a camera and/or sensor mounted on the self-driving vending machine. Correspondingly, the executing unit 402 may determine whether to take a protective measure by analyzing the information about the weather environment.

For example, the executing unit 402 may determine that the protective measure needs to be taken if it is determined according to the information about the weather environment that it is raining. Or, the executing unit 402 may determine that a protective measure needs to be taken if it is determined according to the information about the weather environment that it is raining and the rainfall thereof is larger than a preset first threshold. Or, the executing unit 402 may determine that a protective measure needs to be taken if it is determined according to the information about the weather environment that it is snowing. Or, the executing unit 402 may determine that a protective measure needs to be taken if it is determined according to the information about the weather environment that it is snowing and the snowfall thereof is larger than a preset second threshold. Or, the executing unit 402 may determine that a protective measure needs to be taken if it is determined according to the information about the weather environment that air temperature is higher than a preset third threshold.

If it is determined according to the information about the weather environment that a protective measure needs to be taken, the executing unit 402 may perform protection for the self-driving vending machine according to a preset protective measure.

For example, the executing unit 402 may control a protective device that is disposed on the roof of the self-driving vending machine and capable of covering the self-driving vending machine to be opened. The protective device may be disposed on the top of the vehicle and is in a folded state when not in use. When the protective device needs to be used, the protective device may be controlled to be opened, thereby covering the self-driving vending machine. The protective device does not affect a sensing system of the vehicle. The protective device may be an umbrella, a parasol or the like, depending on practical requirement.

Optionally, when it is determined according to the information about the weather environment that a protective measure needs to be taken, the executing unit 402 may first determine a temporary shelter location, and then may control the self-driving vending machine to drive automatically to the temporary shelter location for parking.

Specifically, the executing unit 402 may determine the temporary shelter location according to the location of the self-driving vending machine, or report the location of the self-driving vending machine to a control center, and obtain the temporary shelter location which is returned by the control center and determined according to the location of the self-driving vending machine.

The determined temporary shelter location may be a temporary shelter location nearest to the self-driving vending machine, or a temporary shelter location with the shortest driving time from the self-driving vending machine.

The temporary shelter location may be a storehouse where the self-driving vending machine can be parked.

After the temporary shelter location is determined, the executing unit 402 may control the self-driving vending machine to drive automatically to the temporary shelter location for parking. How to control the self-driving vending machine to drive automatically to the temporary shelter location is of the prior art.

Reference may be made to relevant depictions in the above method embodiments for specific workflows of the above apparatus embodiment shown in FIG. 4, which will not be detailed any more here.

To sum up, the technical solution of the apparatus embodiment of the present disclosure may be employed to avoid the impacts caused by weather factors to the recognition capability of the sensors of the self-driving vending machine and the user's purchasing behaviors, and thereby ensuring normal use of the self-driving vending machine.

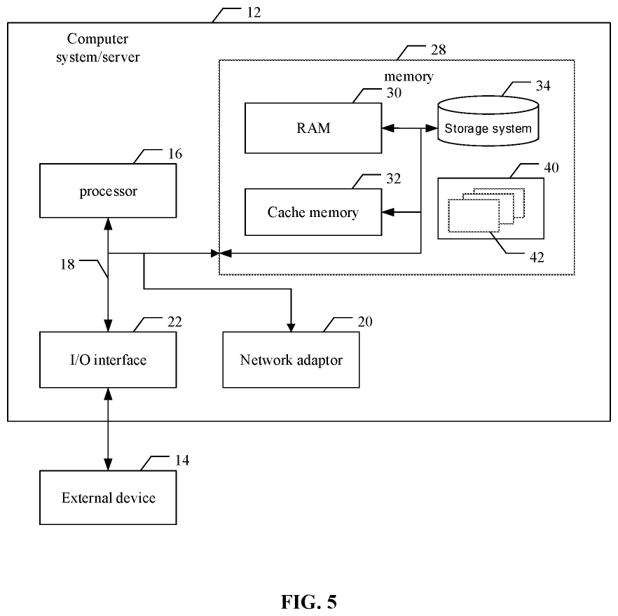

FIG. 5 illustrates a block diagram of an example computer system/server 12 adapted to implement an implementation mode of the present disclosure. The computer system/server 12 shown in FIG. 5 is only an example and should not bring about any limitation to the function and scope of use of the embodiments of the present disclosure.

As shown in FIG. 5, the computer system/server 12 is shown in the form of a general-purpose computing device. The components of computer system/server 12 may include, but are not limited to, one or more processors (processing units) 16, a memory 28, and a bus 18 that couples various system components including system memory 28 and the processor 16.

Bus 18 represents one or more of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

Memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown in FIG. 5 and typically called a “hard drive”). Although not shown in FIG. 5, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each drive can be connected to bus 18 by one or more data media interfaces. The memory 28 may include at least one program product having a set (e.g., at least one) of program modules that are configured to carry out the functions of embodiments of the present disclosure.

Program/utility 40, having a set (at least one) of program modules 42, may be stored in the system memory 28 by way of example, and not limitation, as well as an operating system, one or more disclosure programs, other program modules, and program data. Each of these examples or a certain combination thereof might include an implementation of a networking environment. Program modules 42 generally carry out the functions and/or methodologies of embodiments of the present disclosure.

Computer system/server 12 may also communicate with one or more external devices 14 such as a keyboard, a pointing device, a display 24, etc.; with one or more devices that enable a user to interact with computer system/server 12; and/or with any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted in FIG. 5, network adapter 20 communicates with the other communication modules of computer system/server 12 via bus 18. It should be understood that although not shown, other hardware and/or software modules could be used in conjunction with computer system/server 12. Examples, include, but are not limited to: microcode, device drivers, redundant processing units, external disk drive arrays, RAID systems, tape drives, and data archival storage systems, etc.

The processor 16 executes various function applications and data processing by running programs stored in the memory 28, for example, implement the method in the embodiment shown in FIG. 1, FIG. 2 or FIG. 3.

The present disclosure meanwhile provides a computer-readable storage medium on which a computer program is stored, the program, when executed by the processor, implementing the method stated in the embodiment shown in FIG. 1, FIG. 2 or FIG. 3.

The computer-readable medium of the present embodiment may employ any combinations of one or more computer-readable media. The machine readable medium may be a machine readable signal medium or a machine readable storage medium. A machine readable medium may include, but not limited to, an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the text herein, the computer readable storage medium can be any tangible medium that include or store programs for use by an instruction execution system, apparatus or device or a combination thereof.

The computer-readable signal medium may be included in a baseband or serve as a data signal propagated by part of a carrier, and it carries a computer-readable program code therein. Such propagated data signal may take many forms, including, but not limited to, electromagnetic signal, optical signal or any suitable combinations thereof. The computer-readable signal medium may further be any computer-readable medium besides the computer-readable storage medium, and the computer-readable medium may send, propagate or transmit a program for use by an instruction execution system, apparatus or device or a combination thereof.

The program codes included by the computer-readable medium may be transmitted with any suitable medium, including, but not limited to radio, electric wire, optical cable, RF or the like, or any suitable combination thereof.

Computer program code for carrying out operations disclosed herein may be written in one or more programming languages or any combination thereof. These programming languages include an object oriented programming language such as Java, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

In the embodiments provided by the present disclosure, it should be understood that the revealed apparatus and method can be implemented in other ways. For example, the above-described embodiments for the apparatus are only exemplary, e.g., the division of the units is merely logical one, and, in reality, they can be divided in other ways upon implementation.

The units described as separate parts may be or may not be physically separated, the parts shown as units may be or may not be physical units, i.e., they can be located in one place, or distributed in a plurality of network units. One can select some or all the units to achieve the purpose of the embodiment according to the actual needs.

Further, in the embodiments of the present disclosure, functional units can be integrated in one processing unit, or they can be separate physical presences; or two or more units can be integrated in one unit. The integrated unit described above can be implemented in the form of hardware, or they can be implemented with hardware plus software functional units.

The aforementioned integrated unit in the form of software function units may be stored in a computer readable storage medium. The aforementioned software function units are stored in a storage medium, including several instructions to instruct a computer device (a personal computer, server, or network equipment, etc.) or processor to perform some steps of the method described in the various embodiments of the present disclosure. The aforementioned storage medium includes various media that may store program codes, such as U disk, removable hard disk, Read-Only Memory (ROM), a Random Access Memory (RAM), magnetic disk, or an optical disk.

What are stated above are only preferred embodiments of the present disclosure and not intended to limit the present disclosure. Any modifications, equivalent substitutions and improvements made within the spirit and principle of the present disclosure all should be included in the extent of protection of the present disclosure.

What is claimed is:

1. A method for enabling a self-driving vending machine to cope with a weather environment, comprising:
obtaining information about a weather environment of a place where the self-driving vending machine is located; and
in response to determining that a protective measure needs to be taken according to the information about the weather environment, performing protection for the self-driving vending machine according to a preset protective measure.

2. The method according to claim 1, wherein obtaining information about a weather environment of a place where the self-driving vending machine is located comprises:
obtaining the information about the weather environment collected by at least one of a camera or a sensor mounted on the self-driving vending machine.

3. The method according to claim 1, wherein determining that a protective measure needs to be taken according to the information about the weather environment comprises:
determining that the protective measure needs to be taken when determining, according to the information about the weather environment, that the weather is at least one of the following conditions: it is raining, it is raining and the rainfall thereof is larger than a preset first threshold, it is snowing, it is snowing and the snowfall thereof is larger than a preset second threshold, or air temperature is higher than a preset third threshold.

4. The method according to claim 3, wherein performing protection for the self-driving vending machine according to a preset protective measure comprises:
controlling the opening of a protective device that is disposed on a roof of the self-driving vending machine and capable of covering the self-driving vending machine.

5. The method according to claim 3, wherein performing protection for the self-driving vending machine according to a preset protective measure comprises:
determining a temporary shelter location;
controlling the self-driving vending machine to drive automatically to the temporary shelter location for parking.

6. The method according to claim 5, wherein determining a temporary shelter location comprises:
determining the temporary shelter location according to a location of the self-driving vending machine.

7. The method according to claim 6, wherein determining the temporary shelter location according to a location of the self-driving vending machine comprises:
reporting the location of the self-driving vending machine to a control center;
obtaining the temporary shelter location which is returned by the control center and determined according to the location of the self-driving vending machine.

8. The method according to claim 6, wherein the temporary shelter location comprises at least one of:
a temporary shelter location nearest to the self-driving vending machine; or
a temporary shelter location with the shortest driving time from the self-driving vending machine.

9. A computer device, comprising a memory, a processor and a computer program which is stored on the memory and runs on the processor, wherein the processor, upon executing the program, implements a method for enabling a self-driving vending machine to cope with a weather environment, wherein the method comprises:
obtaining information about a weather environment of a place where the self-driving vending machine is located; and
in response to determining that a protective measure needs to be taken according to the information about the weather environment, performing protection for the self-driving vending machine according to a preset protective measure.

10. The computer device according to claim 9, wherein obtaining information about a weather environment of a place where the self-driving vending machine is located comprises:
obtaining the information about the weather environment collected by at least one of a camera or a sensor mounted on the self-driving vending machine.

11. The computer device according to claim 9, wherein determining that a protective measure needs to be taken according to the information about the weather environment comprises:
determining that the protective measure needs to be taken if determining, according to the information about the weather environment, that the weather is at least one of the following conditions: it is raining, it is mining and the rainfall thereof is larger than a preset first threshold, it is snowing, it is snowing and the snowfall thereof is larger than a preset second threshold, or air temperature is higher than a preset third threshold.

12. The computer device according to claim 11, wherein performing protection for the self-driving vending machine according to a preset protective measure comprises:
controlling the opening of a protective device that is disposed on a roof of the self-driving vending machine and capable of covering the self-driving vending machine.

13. The computer device according to claim 11, wherein performing protection for the self-driving vending machine according to a preset protective measure comprises:
determining a temporary shelter location;
controlling the self-driving vending machine to drive automatically to the temporary shelter location for parking.

14. The computer device according to claim 13, wherein determining a temporary shelter location comprises:
determining the temporary shelter location according to a location of the self-driving vending machine.

15. The computer device according to claim 14, wherein determining the temporary shelter location according to a location of the self-driving vending machine comprises:
reporting the location of the self-driving vending machine to a control center;
obtaining the temporary shelter location which is returned by the control center and determined according to the location of the self-driving vending machine.

16. The computer device according to claim 14, wherein the temporary shelter location comprises at least one of:
a temporary shelter location nearest to the self-driving vending machine; or
a temporary shelter location with the shortest driving time from the self-driving vending machine.

17. A non-transitory computer-readable storage medium on which a computer program is stored, wherein the program, when executed by a processor, implements a method for enabling a self-driving vending machine to cope with a weather environment, wherein the method comprises:
obtaining information about a weather environment of a place where the self-driving vending machine is located; and
in response to determining that a protective measure needs to be taken according to the information about the weather environment, performing protection for the self-driving vending machine according to a preset protective measure.

18. The non-transitory computer-readable storage medium according to claim 17, wherein obtaining information about a weather environment of a place where the self-driving vending machine is located comprises:
obtaining the information about the weather environment collected by at least one of a camera or a sensor mounted on the self-driving vending machine.

19. The non-transitory computer-readable storage medium according to claim 17, wherein determining that a protective measure needs to be taken according to the information about the weather environment comprises:
determining that the protective measure needs to be taken if determining, according to the information about the weather environment, that the weather is at least one of the following conditions: it is raining, it is raining and the rainfall thereof is larger than a preset first threshold, it is snowing, it is snowing and the snowfall thereof is larger than a preset second threshold, or air temperature is higher than a preset third threshold.

20. The non-transitory computer-readable storage medium according to claim 19, wherein performing protection for the self-driving vending machine according to a preset protective measure comprises:
controlling the opening of a protective device that is disposed on a roof of the self-driving vending machine and capable of covering the self-driving vending machine.
